(19) United States
(12) Patent Application Publication
(10) Pub. No.: US 2026/0350531 A1
(43) Pub. Date: Nov. 5, 2026

(54) REFRIGERATOR APPLIANCE FOOD MANAGEMENT MACHINE LEARNING MODEL

(71) Applicant: Haier US Appliance Solutions, Inc., Wilmington, DE (US)

(72) Inventors: Jose Rafael Padron, Louisville, KY (US); Timothy Ray Jackson, Louisville, KY (US)

(21) Appl. No.: 19/194,145

(22) Filed: Apr. 30, 2025

(51) Int. Cl. G06Q 10/087; G06N 20/00; G06T 7/62; G06T 7/70; G06T 7/90

(52) U.S. Cl. CPC G06Q 10/087; G06N 20/00; G06T 7/62; G06T 7/70; G06T 7/90

(57) ABSTRACT

A method of inventory management within a refrigerator appliance includes a controller of the refrigerator appliance initiating a predetermined machine learning model for operating the refrigerator appliance, and performing a detection operation in the refrigerator appliance. The method also includes the controller selecting a tuned machine learning model from a plurality of tuned machine learning models for operating the refrigerator appliance. The selected tuned machine learning model is based on data determined during the detection operation, where the selected tuned machine learning model includes preloaded refrigerator data akin to the data determined during the detection operation. The method further includes adjusting the predetermined machine learning model to the selected tuned machine learning model for operating the refrigerator appliance.

### FIELD OF THE INVENTION

The present subject matter relates generally to inventory management in refrigerator appliances, and more particularly to machine learning models of inventory management systems in refrigerator appliances.

### BACKGROUND OF THE INVENTION

Storage enclosures, such as refrigerator appliances and pantries, generally provide spaces for receiving multiple items or objects. For example, refrigerator appliances generally include a cabinet that defines a chilled food storage chamber. A user generally places food items or objects within the chilled food storage chamber in order to hinder perishing of such food items. Thereby, a useable life of perishable items or objects may be increased.

Over time, a large volume or number of stored items (e.g., food items) can accumulate within the refrigerator's chilled chamber. As stored items accumulate, users of the refrigerator appliance can have difficulty identifying the items located within the refrigerator appliance. Additionally, user can also have difficulty determining a quantity of certain items within the refrigerator appliance. This is especially true when multiple users add/remove items from a common refrigerator appliance without communicating with other users. Consequently, the users may accidentally purchase additional items or more item than they desire. For example, certain food items do not readily perish within the chilled chamber, and such food items may be consumed infrequently. Thus, such food items can remain within the chilled chamber for extended periods of time. The users can forget about such food items and purchase replacements despite already having acceptable items. In such a manner, the users can be inconvenienced or expend money needlessly. Additionally or alternatively, some users may be unaware that certain items have been removed or consumed. Thus, users may fail to replace or replenish such items.

New refrigerator appliances may include features, such as a camera, for assisting a user with viewing or tracking contents of a chilled food storage chamber of the refrigerator appliance. In general, the refrigerator appliance includes software for operating the camera to view or track the contents of the food storage chamber. However, different refrigerator models may be oriented, positioned, colored, spaced, etc., differently such that the software for operating of the camera is inefficient for the operation of the particular refrigerator appliance.

Accordingly, an inventory management system using machine learning may be beneficial. In particular, a refrigerator appliance with a tuned machine learning model may advantageously improve inventory management of food items within the refrigerator appliance as well as overall efficiency of the operation of the refrigerator appliance.

### BRIEF DESCRIPTION OF THE INVENTION

Aspects and advantages of the invention will be set forth in part in the following description, or may be obvious from the description, or may be learned through practice of the invention.

In one example embodiment of the present disclosure, a method of inventory management within a refrigerator appliance is provided. The method includes a controller of the refrigerator appliance detecting a user engagement event, initiating a predetermined machine learning model for operating the refrigerator appliance in response to the user engagement event, capturing, by a camera within the refrigerator appliance, an image of an interior of a food storage chamber within the refrigerator appliance in response to the initiation of the predetermined machine learning model, and determining refrigerator data corresponding to a plurality of characteristics of the refrigerator appliance based on the captured image. The method also includes the controller selecting a tuned machine learning model from a plurality of tuned machine learning models for operating the refrigerator appliance. The selected tuned machine learning model is based on the determined refrigerator data, where the selected tuned machine learning model includes preloaded refrigerator data akin to the determined refrigerator data. The method further includes adjusting the predetermined machine learning model to the selected tuned machine learning model for operating the refrigerator appliance.

In another example embodiment of the present disclosure, a method of inventory management within a refrigerator appliance is provided. The method includes a controller of the refrigerator appliance initiating a predetermined machine learning model for operating the refrigerator appliance, and performing a detection operation in the refrigerator appliance. The method also includes the controller selecting a tuned machine learning model from a plurality of tuned machine learning models for operating the refrigerator appliance. The selected tuned machine learning model is based on data determined during the detection operation, where the selected tuned machine learning model includes preloaded refrigerator data akin to the data determined during the detection operation. The method further includes adjusting the predetermined machine learning model to the selected tuned machine learning model for operating the refrigerator appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a refrigerator appliance according to example embodiments of the present subject matter.

FIG. 2 provides a front elevation view of a refrigerator appliance according to example embodiments of the present subject matter, wherein refrigerator doors are shown in an open position.

FIG. 3 provides a schematic view of a refrigerator appliance according to example embodiments of the present subject matter.

FIG. 4 illustrates an example two-dimensional image of shelves within a fresh food chamber of a refrigerator appliance captured at a camera assembly of the refrigerator appliance according to example embodiments of the present subject matter.

FIG. 5 illustrates a series of two-dimensional images of stored items on a shelf within a chilled chamber of a refrigerator appliance according to example embodiments of the present subject matter.

FIG. 6 illustrates a series of two-dimensional images of stored items on a shelf within a chilled chamber of a refrigerator appliance according to example embodiments of the present subject matter.

FIG. 7 illustrates an example two-dimensional image of a drawer of a refrigerator appliance captured at a camera assembly of the refrigerator appliance according to example embodiments of the present subject matter.

FIG. 8 illustrates a series of two-dimensional images of a stored item in a drawer of a refrigerator appliance according to example embodiments of the present subject matter.

FIG. 9 illustrates a series of two-dimensional images of stored items in a drawer of a refrigerator appliance according to example embodiments of the present subject matter.

FIG. 10 illustrates a series of two-dimensional images of stored items in a drawer of a refrigerator appliance according to example embodiments of the present subject matter.

FIG. 11 illustrates a series of two-dimensional images of stored items in a drawer of a refrigerator appliance according to example embodiments of the present subject matter.

FIG. 12 illustrates a schematic view of two-dimensional images of stored items in a drawer of a refrigerator appliance viewable on an external device according to example embodiments of the present subject matter.

FIG. 13 illustrates a flowchart of an example method of inventory management within a refrigerator appliance according to example embodiments of the present subject matter.

FIG. 14 illustrates a flowchart of another example method of inventory management within a refrigerator appliance according to example embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

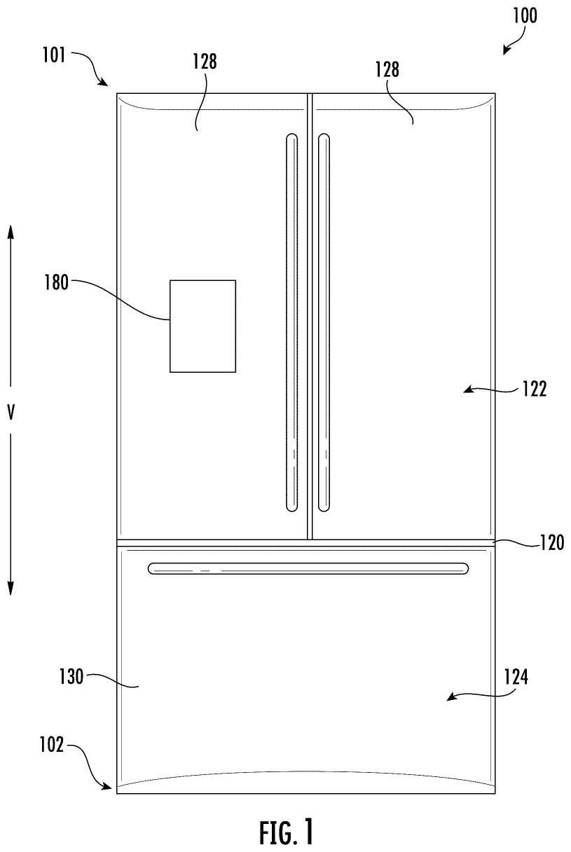

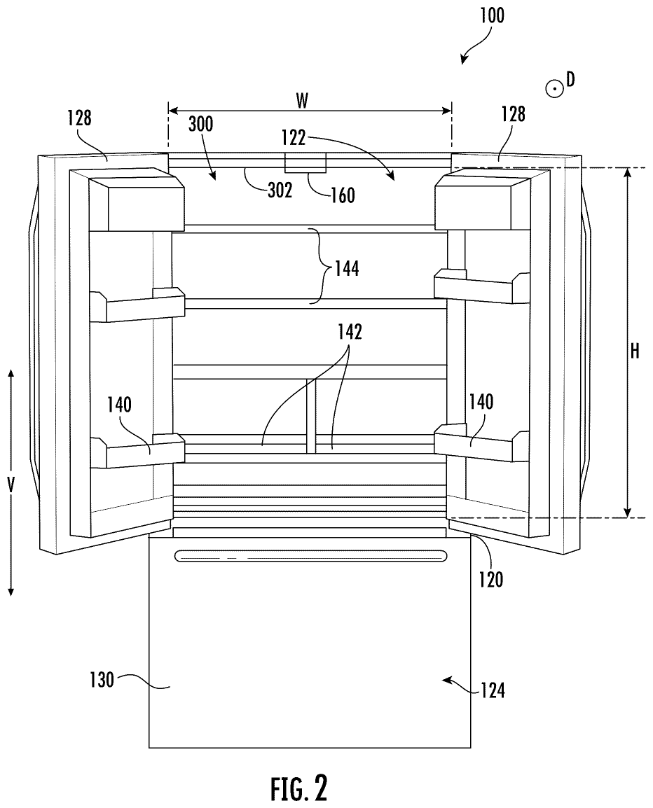

Turning now to the figures, FIG. 1 provides a front elevation view of a refrigerator appliance 100 according to example embodiments of the present disclosure with refrigerator doors 128 of the refrigerator appliance 100 shown in a closed position. FIG. 2 provides a front view elevation of refrigerator appliance 100 with refrigerator doors 128 shown in an open position to reveal a fresh food chamber 122 of refrigerator appliance 100.

Refrigerator appliance 100 includes a cabinet or housing 120 that extends between a top 101 and a bottom 102 along a vertical direction V. Housing 120 defines chilled chambers for receipt of food items for storage. In particular, housing 120 defines fresh food chamber 122 positioned at or adjacent top 101 of housing 120 and a freezer chamber 124 arranged at or adjacent bottom 102 of housing 120. As such, refrigerator appliance 100 is generally referred to as a bottom mount refrigerator. It is recognized, however, that the benefits of the present disclosure apply to other types and styles of storage enclosure, such as a top mount refrigerator appliance, a side-by-side style refrigerator appliance, or an unrefrigerated pantry enclosure. Consequently, the description set forth herein is for illustrative purposes only and is not intended to be limiting in any aspect to any particular storage enclosure or refrigerator chamber configuration.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer 142 (not shown) slidably mounted within freezer chamber 124. As discussed above, refrigerator doors 128 and freezer door 130 are shown in the closed configuration in FIG. 1, and refrigerator doors 128 are shown in the open position in FIG. 2.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted within fresh food chamber 122. Bins 140, drawers 142, and shelves 144 are configured for receipt of stored items (e.g., beverages or solid food items) and may assist with organizing such food items. As an example, drawers 142 can receive fresh food items (e.g., vegetables, fruits, or cheeses) and increase the useful life of such fresh food items.

Refrigerator appliance 100 also includes features for assisting a user with identifying food items positioned within fresh food chamber 122 or freezer chamber 124. The user can utilize such features, for example, to view food items stored within fresh food chamber 122 or freezer chamber 124 or create an inventory of such food items. Such features are discussed in greater detail below.

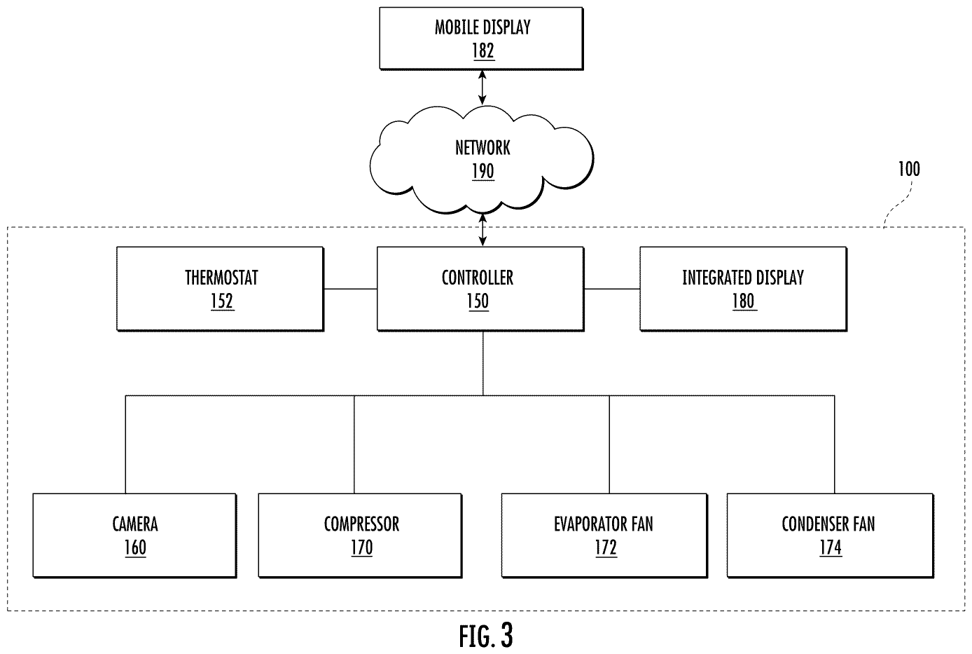

FIG. 3 provides a schematic view of refrigerator appliance 100. Refrigerator appliance 100 includes a controller 150 that is operatively coupled or in communication with components of a refrigeration system (not shown) of refrigerator appliance 100 configured for cooling fresh food chamber 122 or freezer chamber 124. The components include a compressor 170, an evaporator fan 172, and a condenser fan 174. Controller 150 can selectively operate such components in order to cool fresh food chamber 122 or freezer chamber 124. Controller 150 is also in communication with a thermostat 152 (e.g., a thermocouple or thermistor). Thermostat 152 may be positioned in fresh food compartment 122 or freezer compartment 124 (FIG. 2). Controller 150 may receive a signal from thermostat 152 that corresponds to a temperature of fresh food compartment 122 or freezer compartment 124. Controller 150 may also include an internal timer for calculating elapsed time periods.

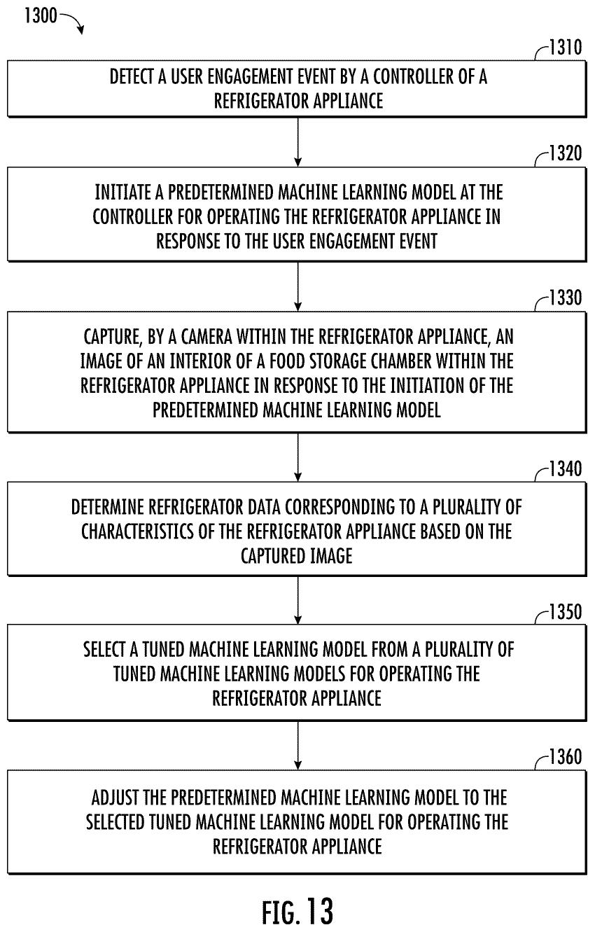

Controller 150 may include a memory and one or more microprocessors, CPUs, or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes non-transitory programming instructions stored in memory. For certain embodiments, the instructions include a software package configured to operate appliance 100 or execute an operation routine (e.g., the example methods described below with reference to FIGS. 13 through 15). The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout refrigerator appliance 100. Input/output (“I/O”) signals may be routed between controller 150 and various operational components of refrigerator appliance 100. One or more components of refrigerator appliance 100 may be in communication (e.g., electric communication) with controller 150 via one or more conductive signal lines or shared communication busses. Additionally or alternatively, one or more components of refrigerator appliance 100 may be in communication (e.g., wireless communication) with controller 150 via one or more wireless signal bands.

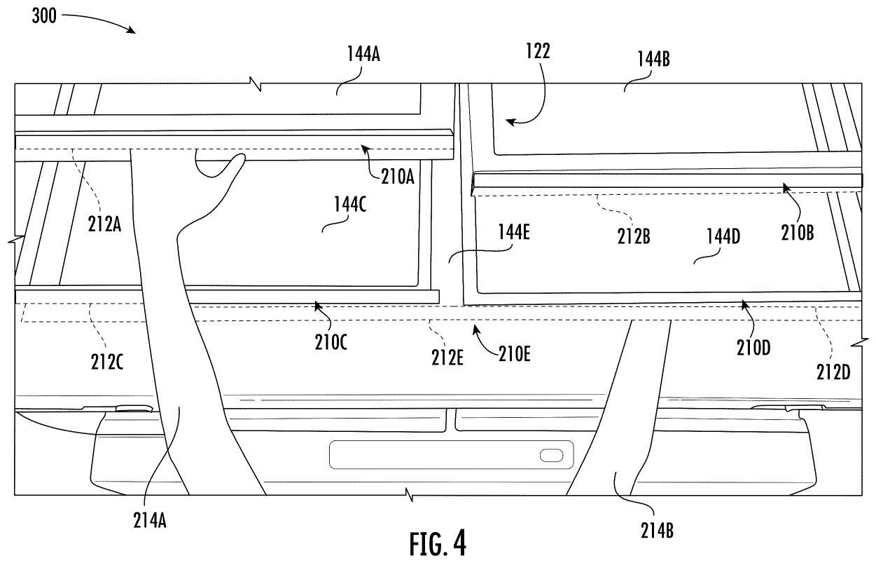

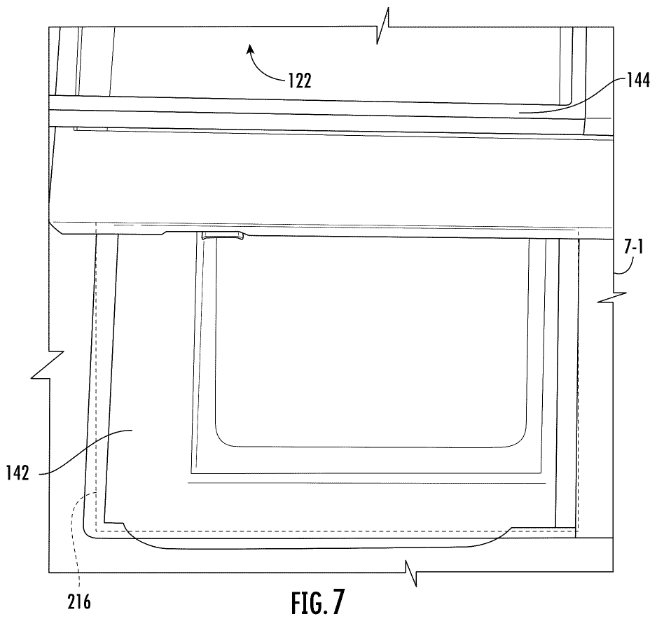

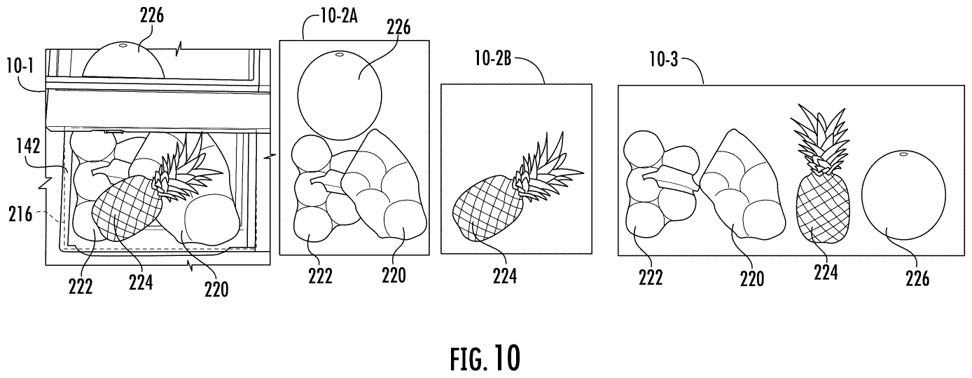

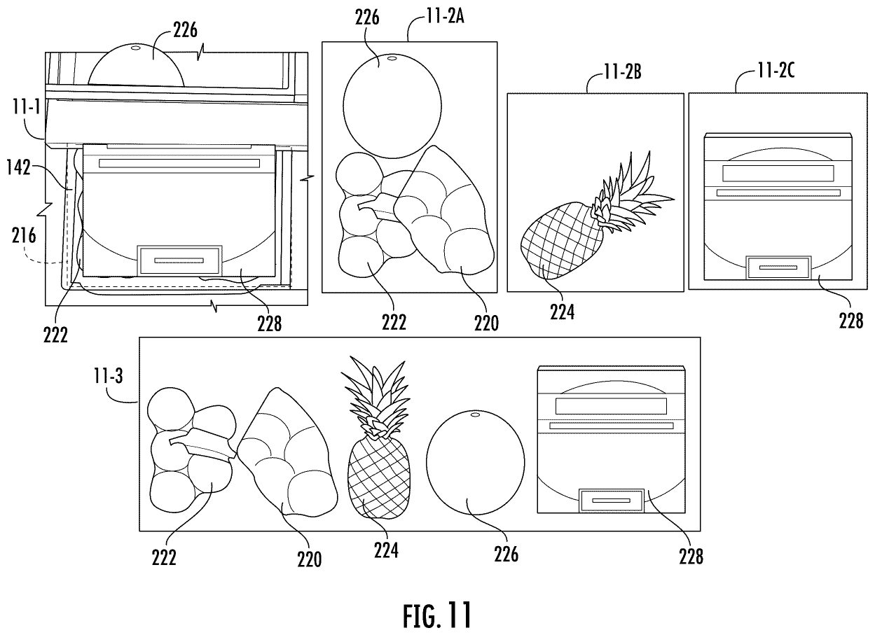

Refrigerator appliance 100 also includes a camera or camera module 160. Camera 160 may be any type of device suitable for capturing a two-dimensional picture or image, such as images illustrated in FIG. 4, FIG. 7 (e.g., 7-1), FIG. 10 (e.g., 10-1), and FIG. 11 (e.g., 11-1). As an example, camera 160 may be a video camera or a digital camera with an electronic image sensor [e.g., a charge coupled device (CCD) or a CMOS sensor]. When assembled, camera 160 is in communication (e.g., electric, or wireless communication) with controller 150 such that controller 150 may receive a signal from camera 160 corresponding to the image captured by camera 160.

Generally, camera 160 is positioned within refrigerator appliance 100 and is directed toward one or more chilled chamber (e.g., fresh food chamber 122—FIG. 2). In some embodiments, camera 160 is mounted within fresh food chamber 122 at a top portion thereof (e.g., adjacent top 101). For instance, camera 160 may be fixed to or directed through a top wall of an internal liner defining fresh food chamber 122. In such embodiments, camera 160 may be directed downward, as illustrated in FIG. 2. When assembled, camera 160 may be directed towards at least a portion of any particular one of or combination of drawers 142 and shelves 144 (FIG. 2). Thus, camera 160 can capture images of one of drawers 142, all of drawers 142, one of shelves 144, all of shelves 144, or any suitable combination thereof.

In certain embodiments, refrigerator appliance 100 includes an integrated display 180. Integrated display 180 may be mounted on refrigerator door 128 (FIG. 1) or at any other suitable location on refrigerator appliance 100. Integrated display 180 is in communication with controller 150 such that integrated display 180 may receive a signal from controller 150 corresponding to an image captured by camera 160. Integrated display 180 can receive such signal from controller 150 and present the image to a user visually. Integrated display 180 may include, for example, a liquid crystal display panel (LCD), a plasma display panel (PDP), or any other suitable mechanism for displaying an image (e.g., a projector).

In additional or alternative embodiments, refrigerator appliance 100 includes a network interface (not shown) that couples refrigerator appliance 100 (e.g., controller 150) to a network 190 such that refrigerator appliance 100 can transmit and receive information over network 190. Network 190 can be any wired or wireless network such as a WAN, LAN, or HAN.

In some such embodiments, refrigerator appliance 100 (e.g., controller 150) is in communication with an external device 182 via network 190. External device 182 110 may be any device configured to communicate over network 190 and display images received therefrom. For example, external device 182 may be a computer, a smartphone, a tablet, or a remote database. External device 182 is in communication with controller 150 such that external device 182 may receive a signal from controller 150 (via network 190) corresponding to a user interface or an image captured by camera 160. External device 182 may receive such signal from controller 150 and present one or more images to a user visually. External device 182 may include, for example, a liquid crystal display panel (LCD), a plasma display panel (PDP), or any other suitable mechanism for displaying an image (e.g., a projector). External device 182 can also include an interface (e.g., tactile inputs, such as buttons, or a graphical user interface) that allows external device 182 to initiate communications with refrigerator appliance 100 over network 190.

During use, such as during an image capture sequence, camera 160 may capture one or more two-dimensional images (e.g., as a video feed or series of sequential static images) that may be transmitted to the controller 150 (e.g., as a data signal), as is generally understood. From the captured images, items (e.g., stored items, such as food, or non-stored items such as a user appendage, a shelf, a movable drawer, etc.) within the field of view for the camera 160 may be automatically identified by the controller 150. As is understood, recognizing, or identifying such items, may be performed by edge matching, divide-and-conquer search, greyscale matching, histograms of receptive field responses, or another suitable routine (e.g., executed at the controller 150 based on one or more captured images from camera 160).

Turning now to FIGS. 4 through 6, various example two-dimensional images related to shelf storage are illustrated, such as might be captured at camera 160 (FIG. 2), viewed at integrated display 180 (FIG. 3), or viewed at external device 182 (FIG. 3).

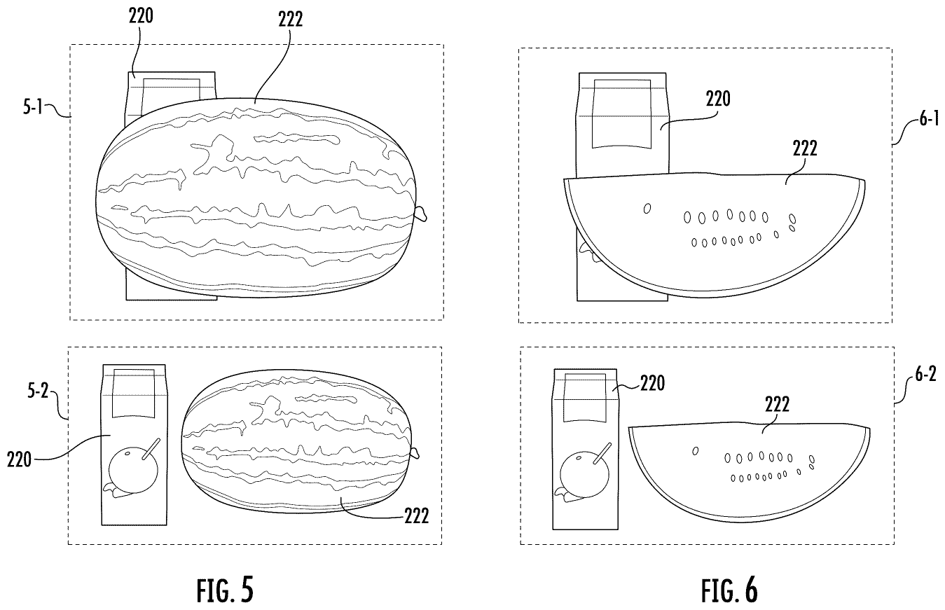

As an example, FIG. 4 illustrates an example two-dimensional image such as might be captured at camera 160 as part of an image capture sequence. In other words, FIG. 4 illustrates a possible field of view for camera 160 directed toward a chilled chamber. As additional or alternative examples, FIGS. 5 and 6 both illustrate a separate series of example two-dimensional images that might be viewed at display 180 or external device 182 after being isolated or generated from an initial image captured at camera 160 as part of an image capture sequence.

In certain embodiments, camera 160 and controller 150 are configured to capture multiple, sequential, two-dimensional images (e.g., at a predetermined rate or pattern) as part of an image capture sequence. Sequential images (e.g., a previously-captured image and a more-recently-captured image) may be recorded (e.g., temporarily) and compared at the controller 150. From the comparison, changes or differences between sequential images may be detected. In some embodiments, the image capture sequence is prompted or initiated in response to detected movement within a chilled chamber (e.g., fresh food chamber 122). The image capture sequence may subsequently be stopped or halted according to one or more end conditions, such as expiration of a predetermined time period, failure to detect further changes in sequential images, or closing of the door 128.

As shown in FIG. 4, at least a portion of multiple shelves 144A, 144B, 144C, 144D, 144E may be visible within the field of view for camera 160 (FIG. 2). Specifically, front edges 210A, 210B, 210C, 210D, 210E of the shelves 144A, 144B, 144C, 144D, 144E may be within the field of view for camera 160 (FIG. 2). Each front edge 210A, 210B, 210C, 210D, 210E may represent the forwardmost surface of a corresponding shelf 144A, 144B, 144C, 144D, 144E, which may be the shelf's surface most proximal to the opening of fresh food chamber 122. For example, as illustrated in FIG. 4, front edge 210A corresponds to shelf 144A, front edge 210B corresponds to shelf 144B, front edge 210C corresponds to shelf 144C, front edge 210D corresponds to shelf 144D, and front edge 210E corresponds to shelf 144E. In some embodiments, one or more of the shelves 144A, 144B, 144C, 144D, 144E are provided at different heights (i.e., relative vertical positions within fresh food chamber 122). Optionally, the camera 160 may be positioned forward from one or more of the shelves 144A, 144B, 144C, 144D, 144E. Thus, the front edges 210A, 210B, 210C, 210D, 210E of shelves 144A, 144B, 144C, 144D, 144E, which are at discrete heights within fresh food chamber 122, may be within the field of view for camera 160.

In certain embodiments, controller 150 is configured to identify a fiducial marker or region of one or more of the shelves 144A, 144B, 144C, 144D, 144E based on signals or images received from the camera 160 (e.g., during an image capture sequence). For instance, from the two-dimensional images captured from the camera 160, the controller 150 may identify a fiducial edge 212A, 212B, 212C, 212D, 212E of one or more of the shelves 144A, 144B, 144C, 144D, 144E. Optionally, a corresponding fiducial edge 212A, 212B, 212C, 212D, 212E may be identified for each shelf 144A, 144B, 144C, 144D, 144E. Together, the fiducial edges 212A, 212B, 212C, 212D, 212E may establish a vertical coordinate system within fresh food chamber 122. Using this vertical coordinate system, controller 150 may be able to determine what shelf 4A, 144B, 144C, 144D, 144E or between which vertically-adjacent shelves 144 (e.g., 144A and 144C), an item or a user appendage 214A, 214B (e.g., hand, arm, etc.). As an example, in the illustrated image of FIG. 4, a user's left arm 214A is shown to cross the fiducial edge 212C without crossing the higher fiducial edge 212A. Thus, it may be determined that the user's left arm 214A is passing between shelf 144A and shelf 144C. As an additional example, in the illustrated image of FIG. 4, a user's right arm 214B is shown to cross the fiducial edge 212E without crossing the higher fiducial edges 212D and 212B. Thus, it may be determined that the user's right arm 214B is passing between shelf 144D and shelf 144E.

Turning especially to FIGS. 5 and 6, in additional or alternative embodiments, controller 150 is configured to identify one or more stored items (e.g., during an image capture sequence). For instance, from the two-dimensional images captured from the camera 160, the controller 150 may identify one or more stored items (e.g., 220, 222) being added to or removed from of one or more of the shelves 144 (FIG. 2). Generally, controller 150 may be configured to initiate or execute an object-recognition sequence or algorithm to identify certain objects, as is understood. Optionally, controller 150 may recognize one or more stored items based on a sub-portion (i.e., less than the entirety) of the two-dimensional profile of the corresponding object. Thus, the controller 150 may calibrate portions of captured two-dimensional images to infer portions of one or more stored items that are hidden, blurred, or otherwise not visible in a captured two-dimensional image.

As an example, and as noted above, FIGS. 5 and 6 illustrate a series of example two-dimensional images that might be viewed at display 180 or external device 182 after being isolated or generated from an initial image captured at camera 160 as part of an image capture sequence. Specifically, two-dimensional image 5-1 illustrates a pair of stored items 220, 222 captured while being placed into fresh food chamber 122. Two-dimensional image 5-2 illustrates an expanded image that has been generated (e.g., by controller 150 from two-dimensional image 5-1) and provides a first stored item 220 (e.g., juice box) spaced apart from a second stored item 222 (e.g., watermelon). Similarly, two-dimensional image 6-1 illustrates a pair of stored items 220, 222 captured while being placed into fresh food chamber 122 (e.g., after a portion of the second stored item 222 has been removed from the remaining portion thereof). Two-dimensional image 6-2 illustrates an expanded image that has been generated (e.g., by controller 150 from two-dimensional image 6-1) and provides the first stored item 220 spaced apart from a second stored item 222.

Although the second stored item 222 partially blocks or covers the first stored item 220 such that only a sub-portion of the first stored item 220 is visible in the captured images, the controller 150 may identify the first stored item 220 (e.g., as well as the second stored item 222). The remaining or blocked portion of the first stored item 220 may be inferred.

In certain embodiments, controller 150 may be configured to record a descriptor of the identified stored items (e.g., within an inventory of stored items detected within refrigerator appliance 100). As an example, the descriptor may include a string of text naming or generally describing the corresponding stored item. As an additional or alternative example, the descriptor may include an image corresponding to the stored item. Such an image of the descriptor may be a captured image (or portion thereof) from camera 160 or, alternatively, a preloaded image received from another remote source (e.g., a remote server). If provided as a preloaded image, the descriptor may provide an image of a substantially identical item. For example, if the stored item is identified as a carton of juice, the descriptor may provide a preloaded image of another (e.g., generic) carton of juice that would be easy for a user to visually distinguish or recognize.

Optionally, an expanded two-dimensional image (e.g., 5-2 or 6-2) may be generated showing the stored items spaced apart from each other such that a user may readily understand what stored items have been captured and identified. Such expanded images may be generated using portions of the captured two-dimensional images at the camera 160 (e.g., wherein captured portions of the stored items are isolated from each other and transferred to the expanded image) or from separate preloaded images stored or received at the controller 150 (e.g., wherein preloaded images of similar items are received from a remote server, such as an Internet server, and transferred to the expanded image).

Images for object recognition may be captured separate from or in addition to images capturing one or more appendages. In some embodiments, one or more determinations may be made (e.g., at controller 150) based on the order in which appendages and stored items are recognized. As an example, if a stored item is recognized or identified (e.g., during an image capture sequence) in a previously-captured image while an appendage (e.g., 214A, 214B) blocking one or more fiducial edges 212A, 212B, 212C, 212D, 212E is identified in a more-recently captured image, controller 150 may determine the stored item is being placed within fresh food chamber 122. Optionally, the internal location or shelf 144 at which the stored item is placed may be recorded (e.g., with or in addition to the corresponding descriptor of the stored item). As an additional or alternative example, if an appendage (e.g., 214A, 214B) blocking one or more fiducial edges 212A, 212B, 212C, 212D, 212E is recognized or identified (e.g., during an image capture sequence) in a previously-captured image while a stored item is recognized or identified is identified in a more-recently captured image, controller 150 may determine stored item is being removed from fresh food chamber 122.

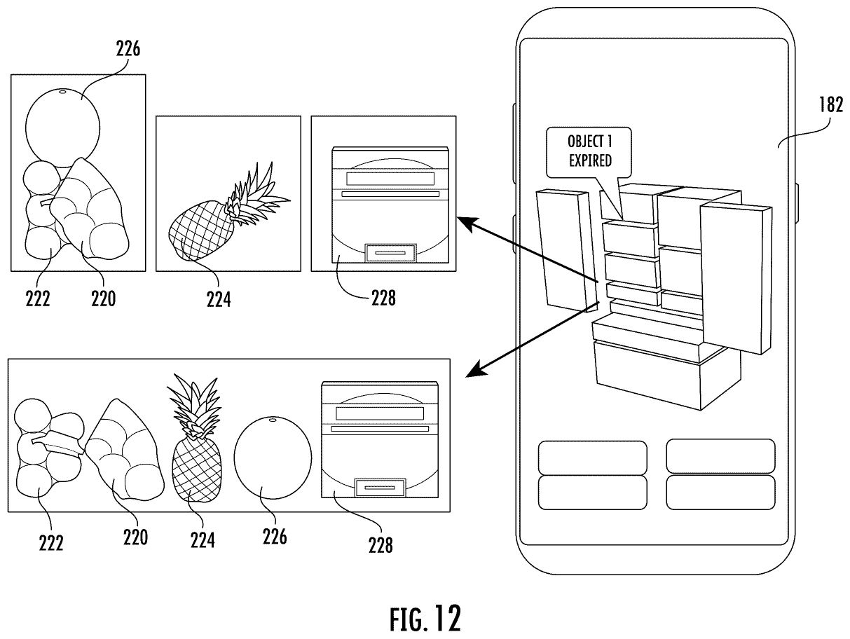

Turning now to FIGS. 7 through 12, various example two-dimensional images related to drawer storage are illustrated, such as might be captured at camera 160 (FIG. 2), viewed at integrated display 180 (FIG. 3), or viewed at external device 182.

As an example, FIG. 7 illustrates an example two-dimensional image 7-1 such as might be captured at camera 160 as part of an image capture sequence. In other words, image 7-1 illustrates a possible field of view (or portion thereof) for camera 160 directed toward chilled chamber. As additional or alternative examples, FIGS. 8 through 11 illustrate separate series of example two-dimensional images that might be viewed at display 180 or external device 182 after being isolated or generated from an initial image captured at camera 160 as part of an image capture sequence.

In certain embodiments, camera 160 and controller 150 are configured to capture multiple, sequential, two-dimensional images (e.g., at a predetermined rate or pattern) as part of an image capture sequence. Sequential images (e.g., a previously-captured image and a more-recently-captured image) may be recorded (e.g., temporarily) and compared at the controller 150. From the comparison changes or differences between sequential images may be detected. In some embodiments, the image capture sequence is prompted or initiated in response to detected movement within or forward from a chilled chamber (e.g., fresh food chamber 122). The image capture sequence may subsequently be stopped or halted according to one or more end conditions, such as expiration of a predetermined time period, failure to detect further changes in sequential images, or closing of the door 128.

In certain embodiments, controller 150 is configured to identify an opened state of at least one drawer 142 within fresh food chamber 122 based on signals or images received from the camera 160 (e.g., during an image capture sequence). For instance, from the two-dimensional images captured from the camera 160, the controller 150 may identify the drawer 142 has been positioned within a predetermined bounding zone 216 of the field of view of camera 160. In some such embodiments, the predetermined bounding zone 216 establishes a two-dimensional footprint or region that is fixed relative to fresh food chamber 122 (e.g., forward therefrom). Optionally, a corresponding predetermined bounding zone 216 may be identified for each drawer 142. Generally, the predetermined bounding zone 216 may establish a corresponding drawer 142 is no longer closed and is at least partially open to permit insertion or removal of stored items. As an example, in the illustrated image of FIG. 7, drawer 142 is received within the predetermined bounding zone 216. Thus, it may be determined that the drawer 142 is open or otherwise in an opened state such that items may pass to/from the storage area of drawer 142.

Turning especially to FIGS. 8 through 11, in additional or alternative embodiments, controller 150 is configured to identify one or more stored items (e.g., during an image capture sequence). For instance, from the two-dimensional images captured from the camera 160, the controller 150 may identify one or more stored items being added to or removed from drawer 142 (e.g., as such stored items pass to/from the predetermined bounding zone 216). Generally, controller 150 may be configured to initiate or execute an object-recognition sequence or algorithm to identify certain objects, as is understood. Optionally, controller 150 may recognize one or more stored items based on a sub-portion (i.e., less than the entirety) of the two-dimensional profile of the corresponding object. Thus, the controller 150 may calibrate portions of captured two-dimensional images to infer portions of one or more stored items that are hidden, blurred, or otherwise not visible in a captured image. Additionally or alternatively, and as will be further described below, controller 150 may determine or select a layer at which the items are placed within the drawer 142.

As an example, and as noted above, FIGS. 8 through 11 illustrate a series of example two-dimensional images that might be viewed at display 180 or external device 182 after being isolated or generated from an initial image captured at camera 160 as part of an image capture sequence. Specifically, FIGS. 8 through 11 illustrate various two-dimensional captured images of stored items identified within the drawer 142, two-dimensional isolated images of identified stored items within selected vertical layers of the drawer 142, and two-dimensional expanded images of all corresponding identified stored items within drawer 142.

Generally, FIGS. 8 through 11 illustrate an example progression of stored items being placed within drawer 142. Each of FIGS. 8 through 11 may be understood to illustrate, for example, additional stored items being placed within drawer 142 during a corresponding image capture sequence. For instance, turning especially to FIG. 8, two-dimensional image 8-1 illustrates a first stored item 220 (e.g., a bag of apples) captured within drawer 142 while drawer 142 is in the predetermined bounding zone 216. Two-dimensional image 8-2 illustrates a two-dimensional isolated image that has been generated (e.g., by controller 150 from two-dimensional image 8-1) to show an isolated first layer within which the first stored item 220 is held. Two-dimensional image 8-3 illustrates a two-dimensional expanded image that has been generated (e.g., by controller 150 from two-dimensional image 8-2) to show all of the stored items within drawer 142 at image 8-1 (i.e., first stored item 220).

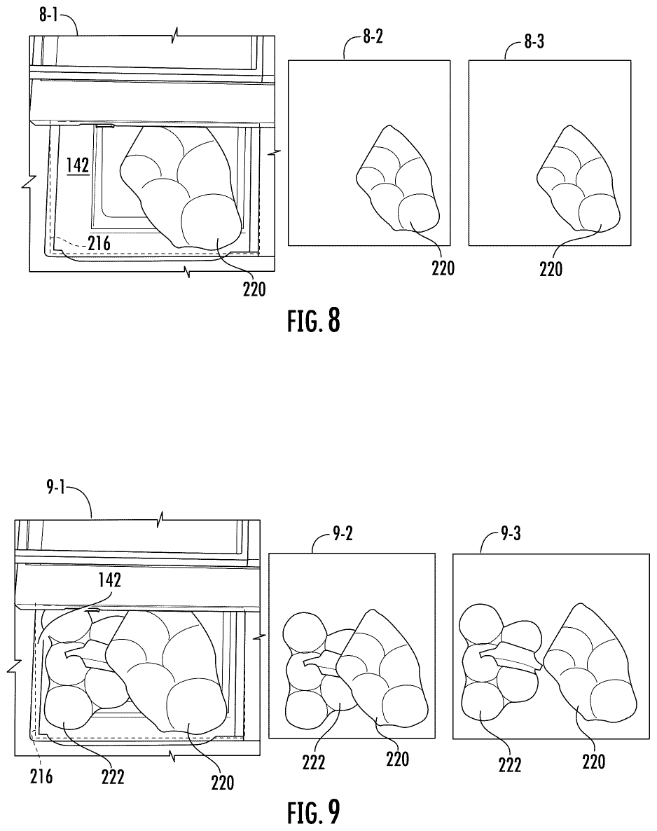

Turning especially to FIG. 9, two-dimensional image 9-1 illustrates the first stored item 220 and a second stored item 222 (e.g., a bag of oranges) captured within drawer 142 (e.g., subsequent to 8-1) while drawer 142 is in the predetermined bounding zone 216. Two-dimensional image 9-2 illustrates a two-dimensional isolated image that has been generated (e.g., by controller 150 from two-dimensional image 9-1) to show an isolated first layer within which the first stored item 220 and second stored item 222 are held. Two-dimensional image 9-3 illustrates a two-dimensional expanded image that has been generated (e.g., by controller 150 from two-dimensional image 9-2) to show all of the stored items within drawer 142 at image 9-1 (i.e., first stored item 220 and second stored item 222) spaced apart from each other.

Turning especially to FIG. 10, two-dimensional image 10-1 illustrates the first stored item 220, the second stored item 222, a third stored item 224 (e.g., a pineapple), and a fourth stored item 226 (e.g., a cantaloupe), captured within drawer 142 (e.g., subsequent to 9-1) while drawer 142 is in the predetermined bounding zone 216. Two-dimensional image 10-2A illustrates a two-dimensional isolated image that has been generated (e.g., by controller 150 from two-dimensional image 10-1 or 9-2) to show an isolated first layer within which the first stored item 220, second stored item 222, and fourth stored item 226 are held. Two-dimensional image 10-2B illustrates a two-dimensional isolated image that has been generated (e.g., by controller 150 from two-dimensional image 10-1) to show an isolated second layer within which the third stored item 224 is held. Two-dimensional image 10-3 illustrates a two-dimensional expanded image that has been generated (e.g., by controller 150 from two-dimensional images 10-2A and 10-2B) to show all of the stored items within drawer 142 at image 10-1 (i.e., first stored item 220, second stored item 222, fourth stored item 226, and third stored item 224) spaced apart from each other.

Turning especially to FIG. 11, two-dimensional image 11-1 illustrates the first stored item 220, the second stored item 222, the third stored item 224, the fourth stored item 226, and a fifth stored item 228 (e.g., a refrigerated pizza) captured within drawer 142 (e.g., subsequent to 10-1) while drawer 142 is in the predetermined bounding zone 216. Two-dimensional image 11-2A illustrates a two-dimensional isolated image that has been generated (e.g., by controller 150 from two-dimensional image 11-1, 9-2, or 10-2A) to show an isolated first layer within which the first stored item 220, second stored item 222, and fourth stored item 226 are held. Two-dimensional image 11-2B illustrates a two-dimensional isolated image that has been generated (e.g., by controller 150 from two-dimensional image 11-1 or 10-2B) to show an isolated second layer within which the third stored item 224 is held. Two-dimensional image 11-2C illustrates a two-dimensional isolated image that has been generated (e.g., by controller 150 from two-dimensional image 11-1) to show an isolated second layer within which the fifth stored item 228 is held. Two-dimensional image 11-3 illustrates a two-dimensional expanded image that has been generated (e.g., by controller 150 from two-dimensional images 11-2A, 11-2B, and 11-2C) to show all of the stored items within drawer 142 at image 11-1 (i.e., first stored item 220, second stored item 222, third stored item 224, fourth stored item 226, and fifth stored item 228) spaced apart from each other.

Returning generally to FIGS. 8 through 12, in certain embodiments, controller 150 may be configured to record a descriptor of the identified stored items (e.g., within an inventory tracking or recording stored items within refrigerator appliance 100). As an example, the descriptor may include a string of text naming or generally describing the corresponding stored item. As an additional or alternative example, the descriptor may include an image corresponding to the stored item. Such an image of the descriptor may be a captured two-dimensional image (or portion thereof) from camera 160 or a preloaded image received from another remote source (e.g., a remote server).

As illustrated in FIGS. 8 through 12, an expanded two-dimensional image may be generated showing the stored items spaced apart from each other such that a user may readily understand what stored items have been captured and recognized. Such expanded images may be generated using portions of the captured images at the camera 160 (e.g., wherein captured portions of the stored items are isolated from each other and transferred to the expanded image) or from separate preloaded images stored or received at the controller 150 (e.g., wherein preloaded images of similar items are received from a remote server, such as an Internet server, and transferred to the expanded image). The isolated or expanded two-dimensional images may be presented to a user (e.g., at external device 182) to provide an easy-to-understand view of items within fresh food chamber 122. Optionally, such images may be presented with an internal location, such that a user may readily discern where a specific stored item is within fresh food chamber 122.

In additional or alternative embodiments, determination or selection of a specific layer may be recorded (e.g., with or as part of the descriptor) as a location for each stored item. In some such embodiments, the specific layer for each stored item may be based, at least in part, in the area of lower stored items that is covered by an upper stored item. For instance, as new stored items are placed within the drawer 142, a determination may be made whether a stored item covers a minimum captured area (e.g., preset minimum threshold percentage) of a captured area of the objects in the previous layers. In other words, if a new stored item is determined to cover or obscure at least the minimum captured area of the total captured area of stored items within drawer 142 (e.g., at an n^{th} layer) prior to the new stored item's placement within drawer 142, the new stored item may be determined to occupy a higher layer (e.g., an immediately higher or n^{th}+1 layer). Generally, the captured area corresponds to the area (e.g., in square millimeters or pixels) occupied by the stored objects within the drawer 142 prior (e.g., immediately prior) to a new stored item being placed and detected within the drawer 142.

In optional embodiments, the minimum captured area is a preset value of 20%. In other embodiments, the minimum captured area is a preset value of 30%. In further embodiments, the minimum captured area is a preset value of 40%.

Using FIG. 10 as an example, in captured image 10-1, the third stored item 224 is determined to cover at least the minimum captured area of the total area defined by the first and second stored items 220, 222 (e.g., as determined from 9-1). Accordingly, the controller 150 may select a new, higher second layer in which the third stored item 224 is positioned. By contrast, the fourth stored item 226 does not cover any other stored items within the captured image of 10-1. Accordingly, the controller 150 may select the first layer in which the fourth stored item 226 is positioned.

Using FIG. 11 as a further example, in the captured image 11-1, the fifth stored item 228 is determined to cover at least the minimum captured area of the area defined by the third stored item 224 in the second layer. Accordingly, the controller 150 may select a new, higher third layer in which the fifth stored item 228 is positioned.

In general, while described with reference to refrigerator appliance 100, aspects of the current subject matter may be incorporated into any suitable refrigerator appliance, refrigerator appliances, or other suitable appliances, such as range appliances, microwave appliances, cooktop appliances. Accordingly, one of skill in the art would understand refrigerator appliance 100 is provided by way of example only.

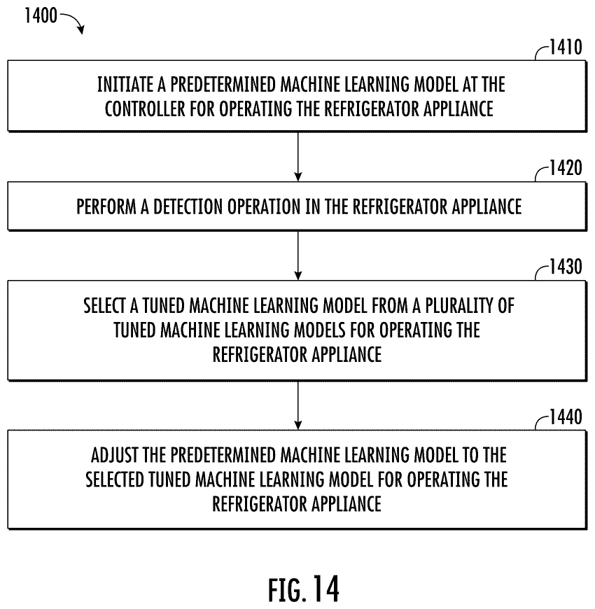

Turning now to FIGS. 13 and 14, illustrated are methods 1300, 1400 of inventory management. Methods 1300, 1400 may include steps performed in a particular order for purposes of illustration and discussion. Those of ordinary skill in the art, using the disclosures provided herein, will understand that the steps of any of the methods discussed herein may be adapted, rearranged, expanded, omitted, or modified in various ways without deviating from the scope of the present disclosure. Moreover, although aspects of methods 1300, 1400 are explained using refrigerator appliance 100 as an example, it should be appreciated that methods 1300, 1400 may be applied to the operation of any suitable refrigerator appliance, e.g., a top mount refrigerator appliance, side-by-side refrigerator appliance, a quad-door refrigerator appliance, etc.

Looking specifically at FIG. 13, at (1310), method 1300 may generally include detecting a user engagement event by a controller of a refrigerator appliance. For example, controller 150 of refrigerator appliance 100 may detect a user engagement event, e.g., a user interaction with refrigerator appliance 100. In general, the use engagement event may include a door, such as refrigerator doors 128 of refrigerator appliance 100, being opened. In other words, at (1310), controller 150 may detect refrigerator doors 128 of refrigerator appliance 100 being opened. One of skill in the art would appreciate controller 150 may detect other user engagement events, such as refrigerator appliance 100 receiving communications from external device 182 over network 190, or another door, such as freezer door 130 of refrigerator appliance 100, being opened.

At (1320), method 1300 may generally include initiating a predetermined machine learning model at the controller for operating the refrigerator appliance in response to the user engagement event. For example, the predetermined machine learning model may be a default, or general machine learning model for operating the refrigerator appliance. In general, a machine learning model for operating a refrigerator appliance, may include preloaded, or default, characteristics of a refrigerator appliance. For example, with respect to the operation of controller 150 and camera 160 described above, controller 150 may account for characteristics such as a position of a camera module (e.g., the position of camera 160), a cabinet depth (e.g., the depth D extending “into the page” as seen in FIG. 2, of fresh food chamber 122), a color of interior 300 of the refrigerator appliance (e.g., the color of liner 302 of fresh food chamber 122), etc.

However, since the characteristics of the predetermined machine learning model are preloaded, or default, the characteristics of the refrigerator appliance may be inaccurate for the particular model of refrigerator appliance within which the controller is mounted, whereby camera 160 and controller 150 may inefficiently/inaccurately process images for food identification and/or management. Specifically, in a scenario where the cabinet depth is actually less than the default cabinet depth of the predetermined machine learning model, the analysis of the resulting images taken by the camera may incur errors, such as inaccurate food identification or management, e.g., when analyzed by the controller with the predetermined machine learning model.

At (1330), method 1300 may generally include capturing, by a camera within the refrigerator appliance, an image of an interior of a food storage chamber within the refrigerator appliance in response to the initiation of the predetermined machine learning model. For example, as described in detail above, camera 160 of refrigerator appliance 100 may capture an image or perform an image capture sequence, where one image or a plurality of images of the interior of the food storage chamber may be captured for analysis by controller 150. In particular, camera 160 within refrigerator appliance 100 is mounted within fresh food chamber 122 at a top portion thereof (e.g., adjacent top 101). As such, when capturing an image, camera 160 captures an image from the top portion of the food storage chamber (fresh food chamber 122).

In general, the image(s), such as the image illustrated by FIG. 4, may be captured in response to the initiation of the predetermined machine learning model, which is initiated in response to the user engagement event. In other example embodiments, the image(s) may be captured directly in response to the user engagement event, rather than in response to the initiation of the predetermined machine learning model.

At (1340), method 1300 may generally include determining, by the controller, refrigerator data corresponding to a plurality of characteristics of the refrigerator appliance based on the captured image. For example, controller 150 may analyze the image(s) captured at (1330) and determine refrigerator data, e.g., the plurality of characteristics of the specific refrigerator appliance controller 150 in mounted within. As stated above, the plurality of characteristics included in the refrigerator data may include the cabinet dimensions of the food storage chamber (e.g., as seen in FIG. 2, width W, depth D, and height H of fresh food chamber 122), a liner color (e.g., the color of liner 302) of the food storage chamber, such as gray or white, and the camera position within the food storage chamber. In other words, determining the refrigerator data includes determining the cabinet dimension, the liner color, and the camera position of the specific refrigerator appliance controller 150 in mounted within, based on the captured image(s). One of skill in the art would appreciate that other characteristics of refrigerator appliance 100 may also be determined from the captured image(s), such as a number of bins, a number of shelves, an orientation of the bins and/or the shelves, etc.

At (1350), method 1300 may generally include selecting, by the controller, a tuned machine learning model from a plurality of tuned machine learning models for operating the refrigerator appliance. The selected tuned machine learning model may be based on the determined refrigerator data. In general, each tuned machine learning model of the plurality of tuned machine learning models may be relevant to respective refrigerator appliances with specific refrigerator data, e.g., specific characteristics relating to cabinet depth, color, orientation, etc. In particular, the selected tuned machine learning model includes preloaded refrigerator data akin to the determined refrigerator data. For example, based on the determined refrigerator data (e.g., the characteristics of refrigerator appliance 100) determined from the captured image(s), a tuned machine learning model, e.g., tuned specifically for refrigerator appliances matching, or substantially similar to, the determined refrigerator data, such as refrigerator appliance 100, may be selected for the operation of the refrigerator appliance.

In some example embodiments, as described above, controller 150 is in communication with external device 182, e.g., a remote database, over network 190, where controller 150 may receive the selected tuned machine learning model for operating the refrigerator appliance from external device 182, such as instead of locally storing the plurality of tuned machine learning models within memory of controller 150.

Accordingly, at (1360), method 1300 may generally include adjusting the predetermined machine learning model to the selected tuned machine learning model for operating the refrigerator appliance. Since the refrigerator data, e.g., the characteristics, of the tuned machine learning model is specific to the determined refrigerator data of the refrigerator appliance, e.g., the particular model of refrigerator appliance within which the controller is mounted, camera 160 and controller 150 may more efficiently and more accurately process images for food identification and/or management. Specifically, in a scenario where the actual cabinet (fresh food storage 122) depth is determined to be less than the default cabinet depth of the predetermined machine learning model, the resulting images taken by camera 160 may be analyzed properly by the tuned machine learning model, thus reducing errors and improving the overall efficiency of the operation of refrigerator appliance 100.

Referring now to FIG. 14, at (1410), method 1400 may generally include initiating a predetermined machine learning model at the controller for operating the refrigerator appliance. As explained above, the predetermined machine learning model may be a default, or general machine learning model for operating the refrigerator appliance, where the predetermined machine learning model for operating the refrigerator appliance, may include preloaded, or default, characteristics of the refrigerator appliance.

At (1420), method 1400 may generally include performing a detection operation in the refrigerator appliance. The detection operation may generally include the steps of detecting a user engagement event, capturing an image of an interior of the food storage chamber, and determining refrigerator data based on the captured image, as described above.

Thus, at (1430), method 1400 may generally include selecting, by the controller, a tuned machine learning model from a plurality of tuned machine learning models for operating refrigerator appliance, where the selected tuned machine learning model is based on data determined during the detection operation. As explained above, controller 150 may analyze the image(s) captured, e.g., during the detection operation, and determine refrigerator data, e.g., the plurality of characteristics of the specific refrigerator appliance controller 150 in mounted within. Thus, controller 150 may determine the refrigerator data such as the cabinet dimension, the liner color, and the camera position of the specific refrigerator appliance controller 150 in mounted within, based on the image(s) captured during the detection operation.

As such, at (1440), method 1400 may generally include adjusting the predetermined machine learning model to the selected tuned machine learning model for operating the refrigerator appliance. In general, method 1400 may further include the controller repeating the detection operation at least a specified number of times before selecting the tuned machine learning model. For example, controller 150 may repeat the detection operation a specified number of between one (1) and fifteen (15) times, such as between two (2) and ten (10) times, such as between three (3) and five (5) times before selecting the tuned machine learning model. In particular, method 1400 may further include the controller recording each iteration of refrigerator data from each repetition of the determined refrigerator data within the detection operation. Further, method 1400 may include the controller selecting the tuned machine learning model based on a summation of each recorded iteration, e.g., an average of the refrigerator data, from each repetition of the determined refrigerator data.

While described above with respect to method 1400, one of skill in the art would appreciate the steps of repeating the detection operation, recording each iteration of refrigerator data, and selecting the tuned machine learning model based on a summation of each recorded iteration may be applied to method 1300, such as by repeating steps (1310) through (1340) the specified number of times before proceeding to step (1350).

In general, after the predetermined machine learning model is adjusted to the selected tuned machine learning model, the selected tuned machine learning model may receive images from camera 160, e.g., camera 160 may capture one or more two-dimensional images of items (such as food, or non-stored items such as a user appendage, a shelf, a movable drawer, etc.) within the field of view for the camera 160. The selected tuned machine learning model of controller 150 may aid controller 150 in automatically identifying the items in the received image. In particular, the resulting images taken by camera 160 may be analyzed by the tuned machine learning model with improved accuracy, improved speed, and/or other improvements from the tuned machine learning model (such as reduced processing load) than the default/predetermined machine learning model, e.g., the tuned machine learning model more accurately defines boundaries such as the cabinet depth D and the positioning of bins 140, drawers 142, and shelves 144. Accordingly, when a user adds and/or removes items from fresh food chamber 122, the selected tuned machine learning model may aid controller 150 in more accurately and efficiently analyzing and managing the added or removed items, e.g., more accurately and efficiently than a refrigerator appliance without a tuned machine learning model.

In some example embodiments, bins 140, drawers 142, and/or shelves 144 may be moveable, or removable from, within fresh food chamber 122. In this regard, controller 150 may be configured to automatically update the selected tuned machine learning model based upon the new orientation of the bins 140, drawers 142, and shelves 144 within fresh food chamber 122. In particular, in a scenario where a user rearranges shelves 144 within fresh food chamber 122, controller 150 may perform another detection operation, e.g., steps (1310) through (1340) of method 1300 or step (1420) of method 1400, to detect new refrigerator data and then select another tuned machine learning model for the updated shelf arrangement.

As may be seen from the above, a method of inventory management in a refrigerator appliance includes selecting a tuned machine learning model. In general, some refrigerator appliances include camera modules to provide inventory management features for consumers, e.g., a camera of the refrigerator appliance captures image(s) for inventory identification and management, where a tuned machine learning model may be selected according to the refrigerator (e.g., characteristics such as cabinet dimensions, liner color, camera position, etc.) that the controller running the tuned machine learning model is mounted within. In particular the camera modules may provide images to the controller to detect dimensions and color of the refrigerator appliance. In particular, once this detection process is completed, the tuned machine learning may be selected for capturing food images and operating the refrigerator appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of inventory management within a refrigerator appliance, the method comprising:
detecting, by a controller of the refrigerator appliance, a user engagement event;
initiating a predetermined machine learning model at the controller for operating the refrigerator appliance in response to the user engagement event;
capturing, by a camera within the refrigerator appliance, an image of an interior of a food storage chamber within the refrigerator appliance in response to the initiation of the predetermined machine learning model;
determining, by the controller, refrigerator data corresponding to a plurality of characteristics of the refrigerator appliance based on the captured image;
selecting, by the controller, a tuned machine learning model from a plurality of tuned machine learning models for operating the refrigerator appliance, the selected tuned machine learning model based on the determined refrigerator data, wherein the selected tuned machine learning model comprises preloaded refrigerator data akin to the determined refrigerator data; and
adjusting the predetermined machine learning model to the selected tuned machine learning model for operating the refrigerator appliance.

2. The method of claim 1, wherein the plurality of characteristics of the refrigerator appliance of the refrigerator data comprises a cabinet dimension of the food storage chamber within the refrigerator appliance, a liner color of the food storage chamber within the refrigerator appliance, and a camera position within the food storage chamber within the refrigerator appliance, wherein determining refrigerator data comprises determining the cabinet dimension of the food storage chamber, the liner color of the food storage chamber, and the camera position within the food storage chamber based on the captured image.

3. The method of claim 1, wherein capturing an image further comprises performing, by the camera of the refrigerator appliance, an image capture sequence, thereby capturing a plurality of images of the interior of the food storage chamber within the refrigerator appliance.

4. The method of claim 1, wherein the user engagement event comprises a door of the refrigerator appliance being opened, wherein detecting the user engagement event comprises detecting the door of the refrigerator appliance being opened.

5. The method of claim 1, wherein a detection operation is defined by the steps of detecting the user engagement event, initiating a predetermined machine learning model, capturing the image of an interior of the food storage chamber, and determining refrigerator data based on the captured image, the method further comprising: repeating, by the controller, the detection operation at least a specified number of times before selecting the tuned machine learning model.

6. The method of claim 5, further comprising recording, by the controller, each iteration of refrigerator data from each repetition of the determined refrigerator data within the detection operation.

7. The method of claim 6, wherein selecting the tuned machine learning model comprises selecting the tuned machine learning model based on a summation of each recorded iteration from each repetition of the determined refrigerator data.

8. The method of claim 1, wherein the controller is in communication with a remote database over a network, the method further comprising receiving the selected tuned machine learning model for operating the refrigerator appliance from the remote database.

9. The method of claim 1, wherein the camera within the refrigerator appliance is positioned at a top portion of the food storage chamber, wherein the step of capturing an image comprises the camera capturing an image from the top portion of the food storage chamber.

10. A method of selecting machine learning model of a refrigerator appliance, the method comprising:
initiating, by a controller of the refrigerator appliance, a predetermined machine learning model at the controller for operating the refrigerator appliance;
performing, by the controller, a detection operation in the refrigerator appliance;
selecting, by the controller, a tuned machine learning model from a plurality of tuned machine learning models, the selected tuned machine learning model based on data determined during the detection operation, wherein the selected tuned machine learning model comprises preloaded refrigerator data akin to the data determined during the detection operation; and
adjusting the predetermined machine learning model to the selected tuned machine learning model for operating the refrigerator appliance.

11. The method of claim 10, wherein the detection operation comprises:
detecting, by a controller of the refrigerator appliance, a user engagement event;
capturing, by a camera within the refrigerator appliance, an image of an interior of a food storage chamber within the refrigerator appliance in response to the initiation of the predetermined machine learning model; and
determining, by the controller, refrigerator data corresponding to one or more characteristics of the refrigerator appliance based on the captured image.

12. The method of claim 11, wherein the plurality of characteristics of the refrigerator appliance of the refrigerator data comprises a cabinet dimension of the food storage chamber within the refrigerator appliance, a liner color of the food storage chamber within the refrigerator appliance, and a camera position within the food storage chamber within the refrigerator appliance, wherein determining refrigerator data comprises determining the cabinet dimension of the food storage chamber, the liner color of the food storage chamber, and the camera position within the food storage chamber based on the captured image.

13. The method of claim 11, wherein capturing an image further comprises performing, by the camera of the refrigerator appliance, an image capture sequence, thereby capturing a plurality of images of the interior of the food storage chamber within the refrigerator appliance.

14. The method of claim 11, wherein the user engagement event comprises a door of the refrigerator appliance being opened, wherein detecting the user engagement event comprises detecting the door of the refrigerator appliance being opened.

15. The method of claim 11, the method further comprising: repeating, by the controller, the detection operation at least a specified number of times before selecting the tuned machine learning model.

16. The method of claim 15, further comprising recording, by the controller, each iteration of refrigerator data from each repetition of the determined refrigerator data within the detection operation.

17. The method of claim 16, wherein selecting the tuned machine learning model comprises selecting the tuned machine learning model based on a summation of each recorded iteration from each repetition of the determined refrigerator data.

18. The method of claim 11, wherein the camera within the refrigerator appliance is positioned at a top portion of the food storage chamber, wherein the step of capturing an image comprises the camera capturing an image from the top portion of the food storage chamber.

19. The method of claim 10, wherein the controller is in communication with a remote database over a network, the method further comprising receiving the selected tuned machine learning model for operating the refrigerator appliance from the remote database.
